(19) United States
(12) Patent Application Publication
(10) Pub. No.: US 2008/0266585 A1
(43) Pub. Date: Oct. 30, 2008

(54) PRINTING APPARATUS AND CONTROL METHOD THEREOF

(75) Inventors: Kazuyuki Iwata, Shizuoka (JP); Kouji Miura, Shizuoka (JP)

Correspondence Address: PEARNE & GORDON LLP, 1801 EAST 9TH STREET, SUITE 1200, CLEVELAND, OH, 44114-3108, US

(73) Assignee: STAR MICRONICS CO., LTD., Shizuoka-shi (JP)

(21) Appl. No.: 11/873,520

(22) Filed: Oct. 17, 2007

(30) Foreign Application Priority Data
Oct. 18, 2006 (JP) 2006-283314

(51) Int. Cl. G06F 15/00

(52) U.S. Cl. 358/1.9

(57) ABSTRACT

A printing apparatus includes: a printing unit that allows a print head to print on a recording medium in a forward path and a return path by reciprocating the print head with respect to the recording medium; a correcting unit that performs correction for a misalignment between printing in the forward path and printing in the return path based on a correction value; an acquisition unit that acquires a temperature inside the printing apparatus or an ambient temperature thereof and/or a counter value which increases or decreases each time a predetermined operation is performed by the printing apparatus; a correction value candidate acquisition unit that acquires correction value candidates based on the temperature and/or the counter value; and a printing example output unit that outputs printing examples of which position discrepancies are corrected in accordance with correction value candidates for each correction value candidate.

### CROSS REFERENCE TO RELATED APPLICATION

This application claims priority from a Japanese Patent Application No. 2006-283314 filed on Oct. 18, 2006, the entire subject matter of which is incorporated herein by reference.

### TECHNICAL FIELD

The present invention relates to a printing apparatus and a control method thereof.

### BACKGROUND

Printing apparatuses that enable a print head thereof to print on a recording medium on its forward and return paths by reciprocating the print head with respect to the recoding medium are known. In such printing apparatuses, a printing position in the forward path and a printing position in the return path may be discrepant from each other in a reciprocating direction of a carriage thereof. This misalignment (hereinafter, referred to as a misalignment) occurs due to non-uniform characteristics of a carriage motor used for reciprocating the print head, an ambient temperature, the number of times of usage, and the like. Thus, in the printing apparatuses, a function for correcting the misalignment between the printing positions in the forward and return paths by advancing or delaying printing timings based on a correction value set by a user is provided.

In the printing apparatuses, users are needed to acquire correction values optimal to the printing apparatuses. In other words, the users are needed to acquire the correction values to be set such that the misalignment can be minimized. Thus, the users using the printing apparatuses are needed to be supported for easily acquiring the correction values that are optimal to the printing apparatuses.

Thus, printing examples for cases where numbers that the correction value can take are set as the correction value are output in the above-described printers. For example, when the correction value can take integer values in the range of 0 to 10, printing examples for cases where one among numbers of 0 to 10 is set as the correction value are output. Accordingly, the user can easily acquire a correction value to be set such that the misalignment can be minimized by referring to the printing examples.

### SUMMARY

In the above-described printing apparatuses, in order for the user to advance or delay the printing timing more delicately, there is a case where more values can be set as the correction value. In such a case, when printing examples for the cases where one of the numbers that the correction value can take is set as the correction value are configured to be output, many printing examples should be output. For example, when the correction value is configured to have an integer from among 0 to 51, 52 types of printing examples should be output.

The present invention is contrived in consideration with the above-described problem. The object of the present invention is to provide a printing apparatus and a control method thereof which are capable of supporting a user to acquire a correction value optimal to the printing apparatus in an easy manner while reducing the output amount of the printing examples.

In order to solve the above-described problem, a printing apparatus according to an embodiment of the invention includes a printing unit that allows a print head to print on a recording medium in a forward path and a return path by reciprocating the print head with respect to the recording medium, a correcting unit that performs correction for a misalignment between printing in the forward path and printing in the return path based on a correction value set by a user, an acquisition unit that acquires a temperature inside the printing apparatus or an ambient temperature thereof and/or a counter value which increases or decreases each time a predetermined operation is performed by the printing apparatus, a correction value candidate acquisition unit that acquires correction value candidates based on the temperature and/or the counter value acquired by the acquisition unit, and a printing example output unit that outputs printing examples of which position discrepancies are corrected in accordance with correction value candidates for each correction value candidate acquired by the correction value candidate acquisition unit.

In addition, a control method for a printing apparatus including a printing unit that allows a print head to print on a recording medium in a forward path and a return path by reciprocating the print head with respect to the recording medium and a correcting unit that performs correction for a misalignment between printing in the forward path and printing in the return path based on a correction value set by a user, according to an embodiment of the invention includes acquiring a temperature inside the printing apparatus or an ambient temperature thereof and/or a counter value which increases or decreases each time a predetermined operation is performed by the printing apparatus, acquiring correction value candidates based on the temperature and/or the counter value which are acquired by the acquiring of a temperature and/or a counter, and outputting printing examples of which position discrepancies are corrected in accordance with correction value candidates for each correction value candidate acquired by the acquiring of correction value candidates.

This embodiment of the present invention relates to a printing apparatus having a printing unit that allows a print head to print on a recording medium in a forward path and a return path by reciprocating the print head with respect to the recording medium and a correcting unit that performs correction for a misalignment between printing in the forward path and printing in the return path based on a correction value set by a user. In this embodiment, a temperature inside the printing apparatus or an ambient temperature thereof and/or a counter value which increases or decreases each time a predetermined operation is performed by the printing apparatus are acquired. In addition, correction value candidates are acquired based on the acquired temperature and/or the counter value acquired. Then, printing examples of which position discrepancies are corrected in accordance with correction value candidates are output for each correction value candidate acquired. According to this embodiment of the present invention, it is possible to support a user to acquire a correction value optimal to the printing apparatus in an easy manner while reducing the output amount of the printing examples.

According to an embodiment of the invention, the correction value candidate acquisition unit may include a correction value candidate information storing unit that stores correction value candidate information used for acquisition of the correction value candidates in correspondence with a condition on the temperature, and acquire the correction value candidates based on the correction value candidate information that is stored in the correction value candidate information storing unit in correspondence with the condition satisfied by the temperature acquired by the acquisition unit.

In this embodiment, the correction value candidate acquisition unit may include a setting time temperature storing unit that stores the temperature inside the printing apparatus or the ambient temperature at a time when the correction value is set by the user as a setting time temperature, the correction value candidate information storing unit may store the correction value candidate information in correspondence with a condition on the temperature and the setting time temperature, and the correction value candidate acquisition unit may acquire the correction value candidates based on the correction value candidate information that is stored in the correction value candidate information storing unit in correspondence with the condition satisfied by the temperature acquired by the acquisition unit and the setting time temperature stored in the setting time temperature storing unit.

According to an embodiment of the invention, the correction value candidate acquisition unit may include a correction value candidate information storing unit that stores correction value candidate information used for acquisition of the correction value candidates in correspondence with a condition on the counter value, and acquire the correction value candidates based on the correction value candidate information that is stored in the correction value candidate information storing unit in correspondence with the condition satisfied by the counter value acquired by the acquisition unit.

In this embodiment, the correction value candidate acquisition unit may include a setting time counter value storing unit that stores the counter value at a time when the correction value is set by the user as a setting time counter value, the correction value candidate information storing unit may store the correction value candidate information in correspondence with a condition on the counter value and the setting time counter value, and the correction value candidate acquisition unit may acquire the correction value candidates based on the correction value candidate information that is stored in the correction value candidate information storing unit in correspondence with the condition satisfied by the counter value acquired by the acquisition unit and the setting time counter value stored in the setting time counter value storing unit.

### BRIEF DESCRIPTION OF THE DRAWINGS

In the accompanying drawings:

FIG. 1 is a diagram showing the whole configuration of a printing apparatus according to an embodiment of the invention;

FIG. 2 is a diagram showing an example of maintenance counter data;

FIG. 3 is a diagram showing an example of correction level data;

FIG. 4 is a diagram showing an example of misalignment correction checking paper;

FIG. 5 is a diagram showing an example of misalignment correction checking paper;

FIG. 6 is a diagram showing an example of misalignment correction checking paper;

FIG. 7 is a diagram showing an example of misalignment correction checking paper;

FIG. 8 is a diagram showing an example of misalignment correction checking paper;

FIG. 9 is a diagram showing an example of misalignment correction checking paper;

FIG. 10 is a diagram showing an example of misalignment correction checking paper;

FIG. 11 is a diagram showing an example of misalignment correction checking paper;

FIG. 12 is a diagram showing an example of state data at the previous setting time;

FIG. 13 is a diagram showing an example of correction level candidate data A;

FIG. 14 is a diagram showing an example of correction level candidate data B;

FIG. 15 is a diagram showing an example of correction level candidate data B;

FIG. 16 is a flowchart showing an example of a process performed by the printing apparatus;

FIG. 17 is a flowchart showing an example of a process performed by the printing apparatus;

FIG. 18 is a diagram showing another example of the correction level candidate data B;

FIG. 19 is a flowchart showing another example of the process performed by the printing apparatus;

FIG. 20 is a flowchart showing another example of the process performed by the printing apparatus;

FIG. 21 is a flowchart showing an example of the process performed by the printing apparatus; and

FIG. 22 is a functional block diagram of a printing apparatus according to an embodiment of the invention.

### DETAILED DESCRIPTION

Hereinafter, embodiments of the present invention will be described in detail with reference to the accompanying drawings.

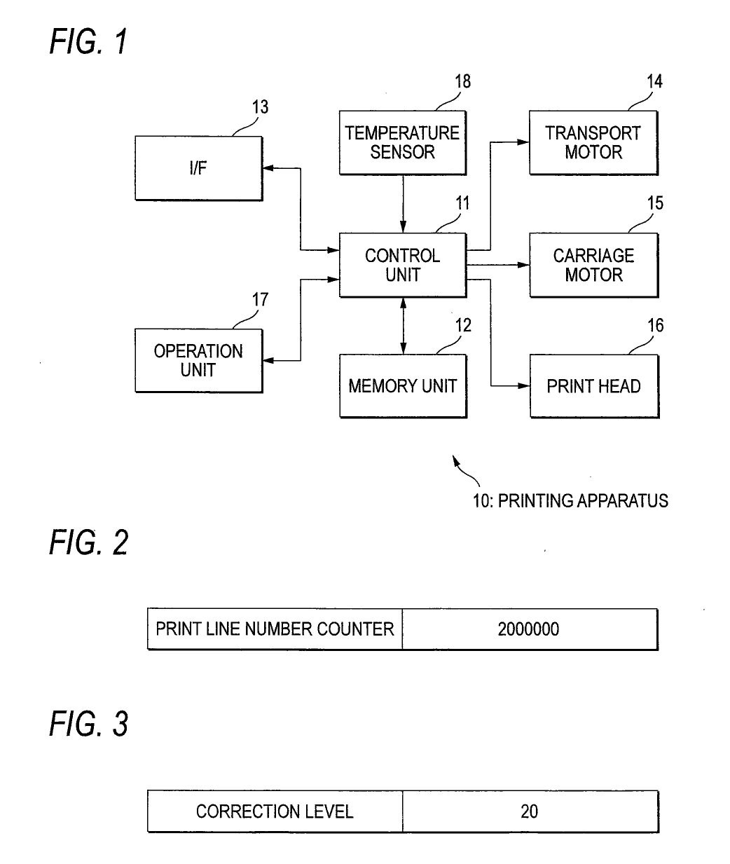

FIG. 1 is a diagram showing the whole configuration of a printing apparatus according to an embodiment of the invention. As shown in FIG. 1, the printing apparatus 10 according to this embodiment includes a control unit 11, a memory unit 12, an interface (I/F) 13, a transport motor 14, a carriage motor 15, a print head 16, an operation unit 17, and a temperature sensor 18.

The control unit 11 is operated in accordance with a program stored in the memory unit 12 and performs control of the overall printing apparatus 10. The memory unit 12, for example, is configured to include a computer-readable data storage medium such as a ROM (Read Only Memory), or a RAM (Random Access Memory). In the memory unit 12, a program or data is stored. The memory unit 12 is also operated as a work memory that is used for storing data for performing various processes.

The interface 13 is used for communication connection with a host computer (not shown in the figure) for data transmission or data reception. The interface 13 receives print data such as a document or an image from the host computer and supplies the print data to the control unit 11. The operation unit 17 is used for various direction operations for the printing apparatus 10. The temperature sensor 18 detects a temperature inside the printing apparatus 10 or a peripheral area thereof.

The transport motor 14 is a stepping motor for transporting a recording medium such as paper in a predetermined direction. The carriage motor 15 is a stepping motor used for reciprocating a carriage in which the print head 16 is built in a direction perpendicular to a transport direction of the recording medium. By forwardly or backwardly rotating the carriage motor 15, the carriage reciprocates through a driving mechanism (not shown in the figure) such as a timing belt or a drive shaft. The print head 16 is built in the carriage and performs a printing operation on a recording medium. The printing apparatus 10 drives the print head 16 in the forward and return paths based on the print data while reciprocating the print head 16 with respect to the recording medium, and thereby printing a text or an image based on the print data on the recording medium.

In the memory unit 12, maintenance counter data is stored. The maintenance counter data represents the accumulated number of times of various operations performed by the printing apparatus 10. FIG. 2 shows an example of the maintenance counter data. In FIG. 2, “print line number counter” is numeric information showing the number of lines that are printed by the printing apparatus 10 until now. A value of the printing line number is increased by one each time when the printing apparatus 10 prints one line.

The printing apparatus 10 has a function (misalignment correcting function) of correcting discrepancy between printing positions in the forward and return paths by correcting the printing timings in the forward and return paths. A correction level of the printing apparatus 10 indicating the degree of correction of the printing timings in the forward and return paths is designated by a user. The printing apparatus 10 advances or delays the printing timings based on the correction level designated by the user.

In the memory unit 12, correction level data is stored. The correction level data indicates the correction level designated by the user. FIG. 3 shows an example of the correction level data. The correction level takes an integer value in the range of 0 to 51. When the correction level is 25, it indicates that the printing timings in the forward and return paths are scarcely corrected. In addition, when the correction level is in the range of 0 to 24, it indicates that the printing timings in the forward and return paths are advanced. In such a case, as the value of the correction level decreases, the degree of advancing the printing timings in the forward and return paths increases. In other words, when the correction level is set to “0”, the degree of advancing the printing timings in the forward and return paths becomes the maximum. In addition, when the correction level is in the range of 26 to 51, it indicates that the printing timings in the forward and return paths are delayed. In such a case, as the value of the correction level increases, the degree of delaying the printing timings in the forward and return paths increases. In other words, when the correction level is set to 51, the degree of delaying the printing timings in the forward and return paths becomes the maximum.

The correction level data is updated when an operation (hereinafter, referred to as a correction level designating operation) for designating the correction level is performed by the user. The correction level designating operation is performed by using the operation unit 17. The correction level data may be configured to be updated when a predetermined command for designation of the correction level is received from the host computer through the interface 13.

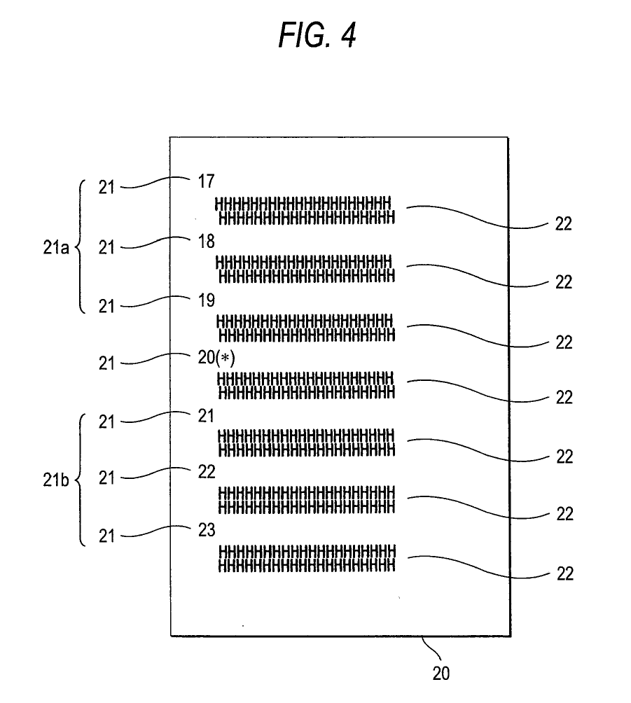

For the printing apparatus 10 having the function of the misalignment correcting function, it is needed to support the user in designation of the correction level such that the user can easily acquire a correction level optimal to the printing apparatus 10. Thus, the printing apparatus 10, for example, outputs misalignment correction checking paper as shown in FIGS. 4 to 11. The misalignment correction checking paper is output when a predetermined operation (hereinafter, referred to as a checking paper output directing operation) is performed by using the operation unit 17.

As shown in FIGS. 4 to 11, on the misalignment correction checking paper 20, a plurality of correction level candidates 21 is output. In addition, on the misalignment correction checking paper 20, printing examples 22 corresponding to the correction level candidates 21 are output. The printing examples 22 are formed by printing a character string including a predetermined number of letters “H” in the forward and return paths under the misalignment correction in accordance with the correction level candidates 21. In each printing examples 22, the first line is formed by printing in the forward path, and the second line is formed by printing in the return path. On the misalignment correction checking paper 20, a correction level candidate 21 to which a (*) mark is attached indicates a current correction level (a correction level currently maintained in the correction level data).

The correction level candidates 21 presented on the misalignment correction checking paper 20 is determined as follows.

Since components (a timing belt, a drive shaft, and the like) related with the driving mechanism of the carriage contract or the like in accordance with an ambient temperature thereof, moving speed of the carriage varies depending on the ambient temperature. As a result, the degree of the misalignment varies depending on the ambient temperature. Accordingly, the value of the correction level to be set in the printing apparatus 10 changes based on the ambient temperature. Thus, in the printing apparatus 10, the correction level candidates 21 presented on the misalignment correction checking paper 20 are determined based on the temperature detected by the temperature sensor 18. To be more specific, the correction level candidates 21 presented on the misalignment correction checking paper 20 are determined based on a current temperature (hereinafter, referred to as a current temperature) detected by the temperature sensor 18 and a temperature (hereinafter, referred to as a temperature at the previous setting time) at a time when the current correction level is set.

FIG. 4 shows an example of the misalignment correction checking paper 20 in a case where the current temperature scarcely changes from the temperature at the previous setting time. When the current temperature scarcely changes from the temperature at the previous setting time, the correction level does not needed to be changed much from its current value. Thus, as shown in FIG. 4, values around the current correction level are presented as the correction level candidates 21.

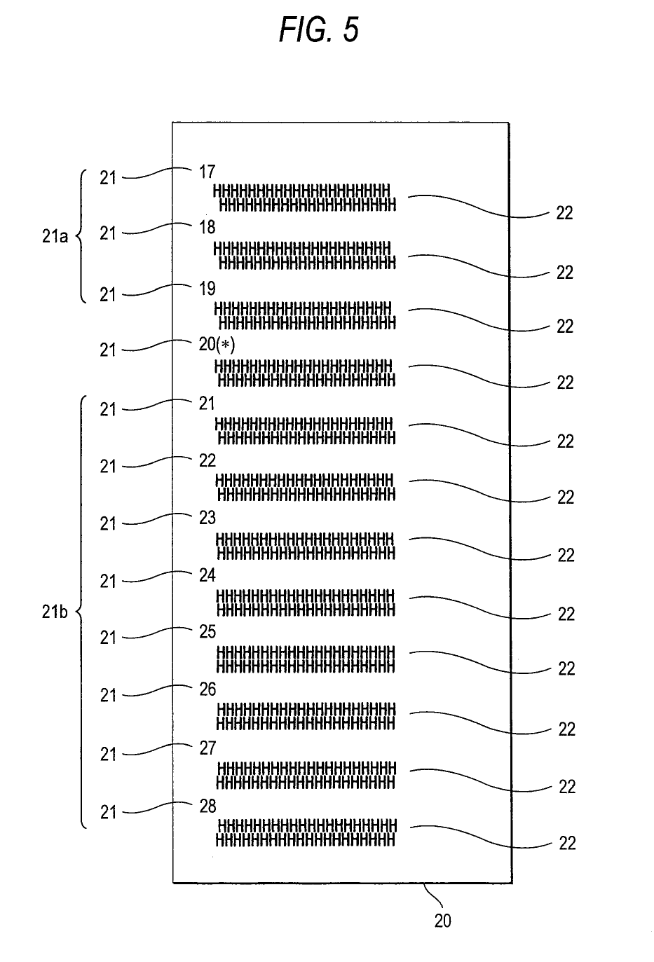

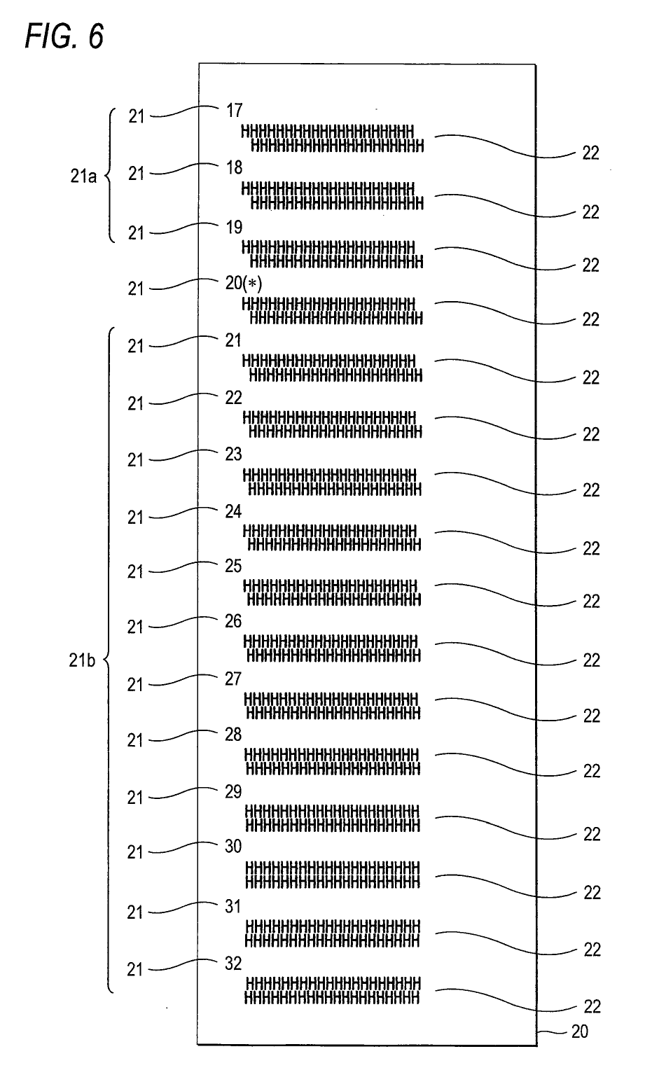

FIGS. 5 and 6 show examples of the misalignment correction checking paper 20 in cases where the current temperature is lower than the temperature at the previous setting time. FIG. 6 shows the misalignment correction checking paper 20 in a case where there is a relatively large difference between the current temperature and the temperature at the previous setting time, compared with the case shown in FIG. 5.

Since components (a timing belt, a drive shaft, and the like) related with the driving mechanism of the carriage contract when the ambient temperature decreases, the moving speed of the carriage decreases. Thus, when the ambient temperature decreases, in order to prevent the generation of the misalignment, the printing timings in the forward and return paths are needed to be delayed. Accordingly, when the current temperature is lower than the temperature at the previous setting, there is a high probability that the value of the correction level should be increased so as to delay the printing timings. Thus, when the current temperature is lower than the temperature at the previous setting, as shown in FIGS. 5 and 6, many correction level candidates 21b whose correction levels are higher than the current correction level are presented, compared with a case where the current temperature does scarcely changes from the temperature at the previous setting time (FIG. 4).

In such a case, when the difference between the current temperature and the temperature at the previous setting is relatively large, there is a high probability that the value of the correction level should be increased further so as to further delay the printing timings, compared with a case where the difference is relatively small. Thus, when the difference between the current temperature and the temperature at the previous setting is relatively large, as shown in FIG. 6, many correction level candidates 21b whose correction levels are higher than the current correction level are presented, compared with a case where the difference between the current temperature and the temperature at the previous setting is relatively small (FIG. 5).

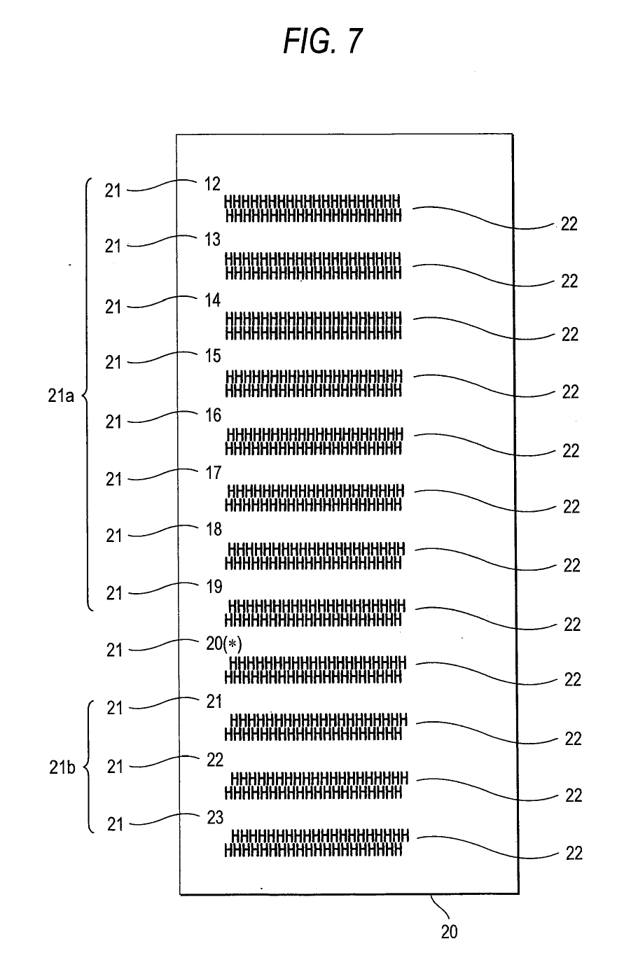

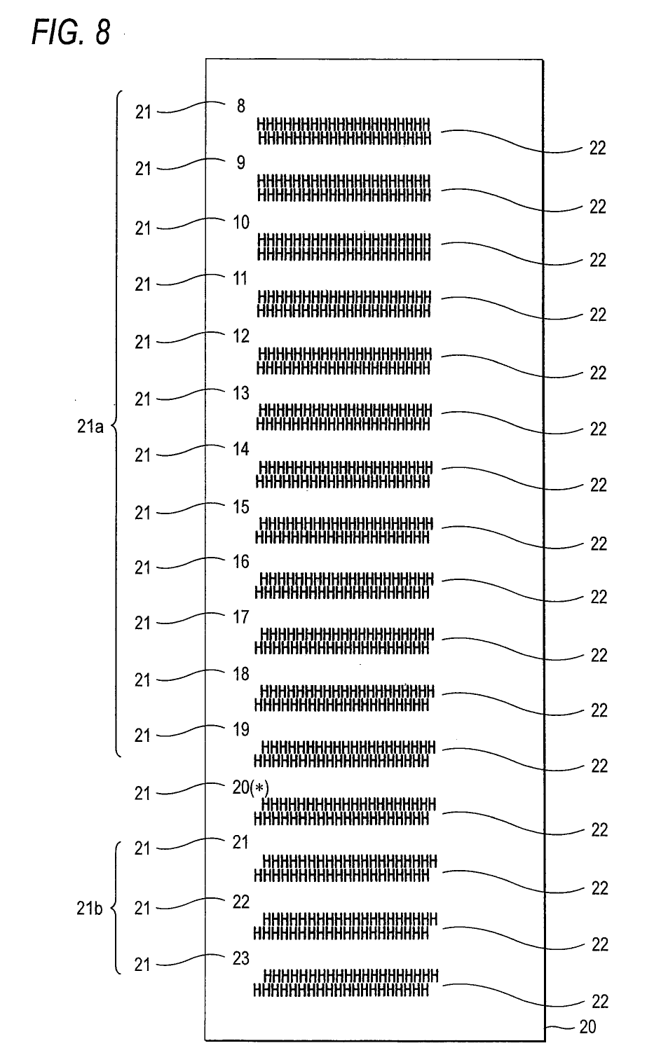

FIGS. 7 and 8 show the misalignment correction checking paper 20 in cases where the current temperature is higher than the temperature at the previous setting. FIG. 8 shows the misalignment correction checking paper 20 in a case where the difference between the current temperature and the temperature at the previous setting is larger than in the case shown in FIG. 7.

On the other hand, when the ambient temperature increases, the moving speed of the carriage increases, which is opposite to the case where the ambient temperature decreases. Thus, when the ambient temperature increases, in order to prevent the generation of the misalignment, the printing timings in the forward and return paths are needed to be advanced. Accordingly, when the current temperature is higher than the temperature at the previous setting, there is a high probability that the value of the correction level should be decreased so as to advance the printing timings. Thus, when the current temperature is higher than the temperature at the previous setting, as shown in FIGS. 7 and 8, many correction level candidates 21a whose correction levels are lower than the current correction level are presented, compared with a case where the current temperature does scarcely changes from the temperature at the previous setting time (FIG. 4).

In such a case, when the difference between the current temperature and the temperature at the previous setting is relatively large, there is a high probability that the correction level should be decreased further so as to further advance the printing timings, compared with a case where the difference is relatively small. Thus, when the difference between the current temperature and the temperature at the previous setting is relatively large, as shown in FIG. 8, many correction level candidates 21a whose correction levels are lower than the current correction level are presented, compared with a case where the difference between the current temperature and the temperature at the previous setting is relatively small (FIG. 7).

The components (a timing belt, a drive shaft, and the like) related with the driving mechanism of the carriage are slowly worn away as the printing apparatus 10 is used. Thus, as the printing apparatus 10 is used, the moving speed of the carriage decreases. As a result, the degree of the misalignment increases as the printing apparatus 10 is used. Accordingly, the value of the correction level to be set in the printing apparatus 10 is changed as the printing apparatus 10 is used. Thus, in the printing apparatus 10, the correction level candidates 21 presented on the misalignment correction checking paper 20 are determined based on the value of a print line number counter. To be more specific, the correction level candidates 21 presented on the misalignment correction checking paper 20 are determined based on a current value of the print line number counter (hereinafter, referred to as a current counter value) and a value of the print line number counter (hereinafter, referred to as a counter value at the previous setting time) at a time when the current correction level is set.

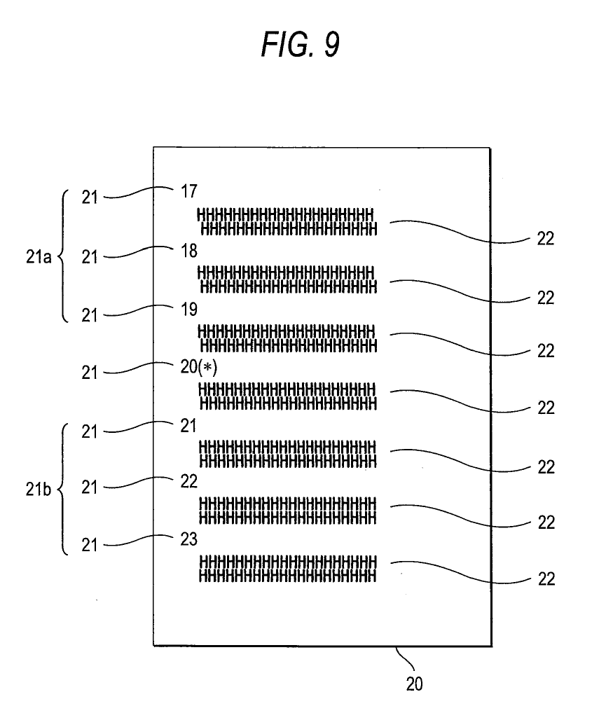

FIG. 9 shows an example of the misalignment correction checking paper 20 in a case where the current counter value does not change much from the counter value at the previous setting time. When the current counter value does not change much form the counter value at the previous setting time, the correction level does not needed to be changed much from its current value. Thus, as shown in FIG. 9, values around the current correction level are presented as the correction level candidates 21.

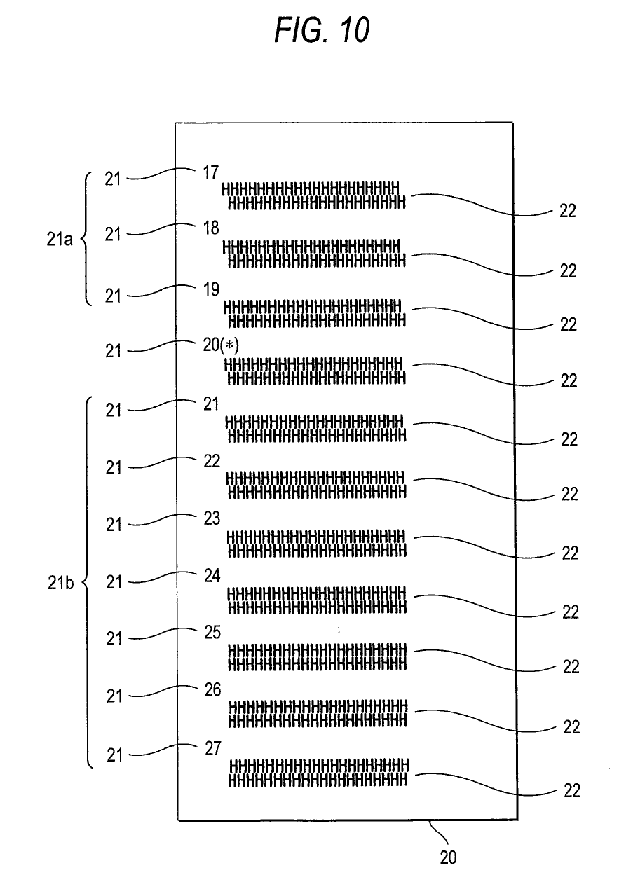

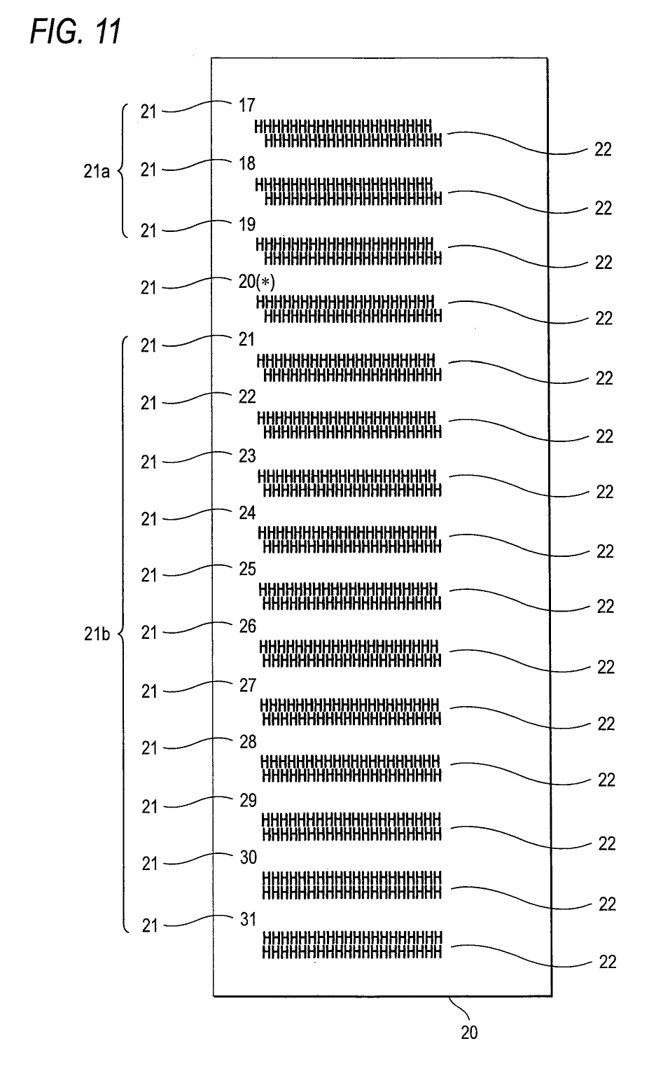

FIGS. 10 and 11 show examples of the misalignment correction checking paper 20 in cases where the current counter value is increased to some degree from the counter value at the previous setting time. FIG. 11 shows the misalignment correction checking paper 20 in a case where there is a relatively large difference between the current counter value and the counter value at the previous setting time, compared with the case shown in FIG. 10.

As described above, when the current counter value is increased from the counter value at the previous setting time to some degree, there is a high probability that the correction level should be increased so as to delay the printing timings. Thus, when the current counter value is increased from the counter value at the previous setting time to some degree, as shown in FIGS. 10 and 11, many correction level candidates 21b whose correction levels are higher than the current correction level are presented, compared with a case where the current counter value does not change much from the counter value at the previous setting time (FIG. 9).

In such a case, when the difference between the current counter value and the counter value at the previous setting is relatively large, there is a high probability that the correction level should be increased further so as to further delay the printing timings, compared with a case where the difference is relatively small. Thus, when the difference between the current counter value and the counter value at the previous setting is relatively large, as shown in FIG. 11, many correction level candidates 21b whose correction levels are higher than the current correction level are presented, compared with a case where the difference between the current counter value and the counter value at the previous setting is relatively small (FIG. 10).

By outputting the misalignment correction checking paper 20, the user can visually acquire a value of the correction level at which the misalignment between the printing (first line) position in the forward path and the printing position (second line) in the return path is the minimum, at once. For example, when the misalignment correction checking paper 20 shown in FIG. 4 is output, the user can visually acquire that the value of the correction level should be set to “22” at once so as to minimize the value of the correction level.

The correction level candidates 21 presented on the misalignment correction checking paper 20 are narrowed down based on the temperature or the print line counter value. Accordingly, a large quantity of printing examples 22 is not unnecessarily output on the misalignment correction checking paper 20.

However, as a method of preventing output of a large quantity of unnecessary printing examples 22 on the misalignment correction checking paper 20, a method in which the correction level candidates 21 to be presented on the misalignment correction checking paper 20 are limited to a predetermined number of values adjacent to the value of the current correction level without being dependent on the temperature or the print line counter value may be considered. In other words, for example, a method in which the misalignment correction checking paper 20 shown in FIG. 4 is output all the time by limiting the correction level candidates 21 to be presented on the misalignment correction checking paper 20 to the values that are consecutive three values after the value of the current correction level and consecutive three values prior to the value of the current correction level without using the temperature or the print line counter value may be considered. However, when this method is employed, if the temperature or the print line counter value changes relatively much from that at the previous correction level setting time, there is a problem that a correction level (the correction level at which the misalignment can be minimized) optimal to the printing apparatus 10 may not be presented on the misalignment correction checking paper 20 as the correction level candidates 21. In view of this problem, in this embodiment, it is possible to ensure that the correction level optimal to the printing apparatus 10 is presented on the misalignment correction checking paper 20 as the correction level candidate 21 even when the temperature or the print line counter value changes relatively much from that at the previous correction level setting time.

Hereinafter, a configuration for output of the misalignment correction checking paper 20 will be described.

First, data stored in the memory unit 12 will be described.

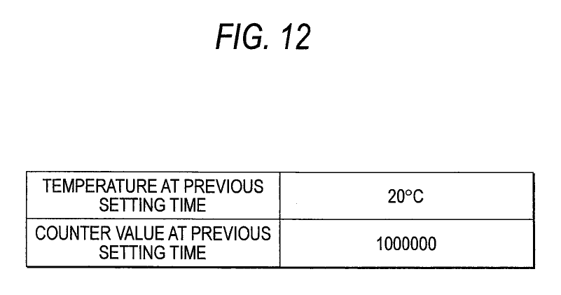

In the memory unit 12, state data at the previous setting time is stored. FIG. 12 shows an example of the state data at the previous setting time. As shown in FIG. 12, the state data at the previous setting time is data for indicating the temperature at the previous setting time and the counter value at the previous setting time.

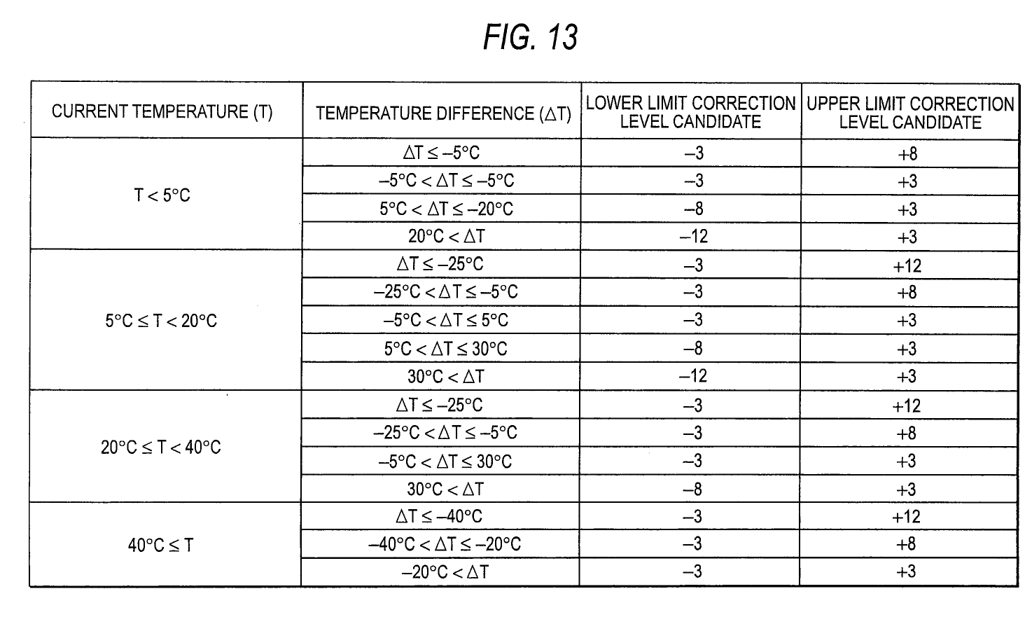

In addition, in the memory unit 12, the correction level candidate data A and B are stored. FIG. 13 shows the correction level candidate data A. As shown in FIG. 13, the correction level candidate A includes a “current temperature” field, a “temperature difference” field, a “lower limit correction level candidate” field, and an “upper limit correction level candidate” field. The correction level candidate A is a table in which a combination of the “current temperature” and the “temperature difference” and a combination of the “lower limit correction level candidate” and the “upper limit correction level candidate” are corresponded to each other. Here, the “current temperature” field represents the range of the current temperature. The “temperature difference” field represents the range of a temperature difference acquired by subtracting the temperature at the previous setting time from the current temperature. The “lower limit correction level candidate” field represents the lower limit of the correction level candidates presented on the misalignment correction checking paper 20 by indicating a difference between the current correction level and the lower limit of the correction level candidates 21. Similarly, the “upper limit correction level candidate” field represents the upper limit of the correction level candidates presented on the misalignment correction checking paper 20 by indicating a difference between the current correction level and the upper limit of the correction level candidates 21.

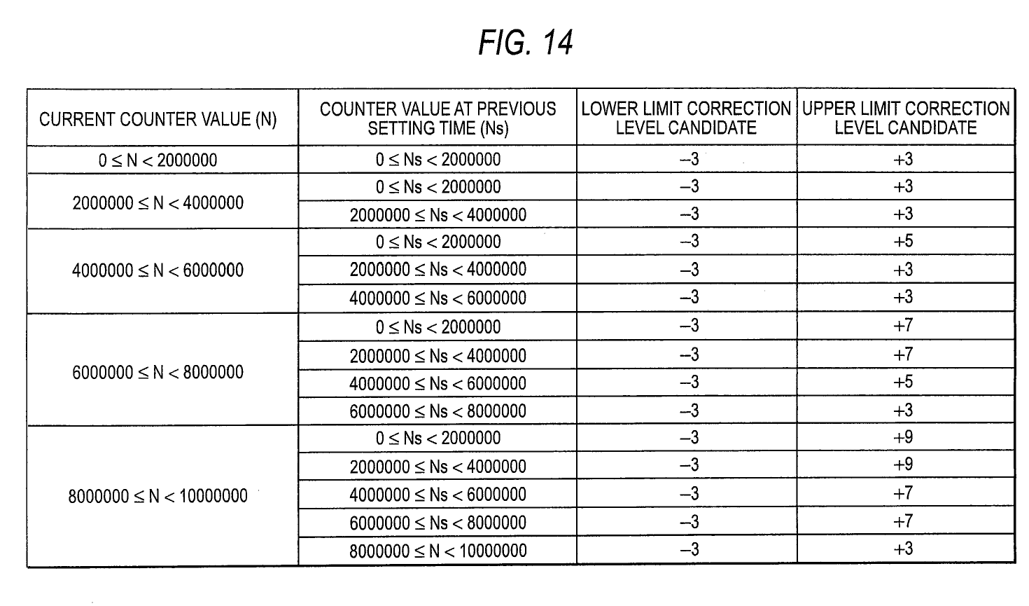

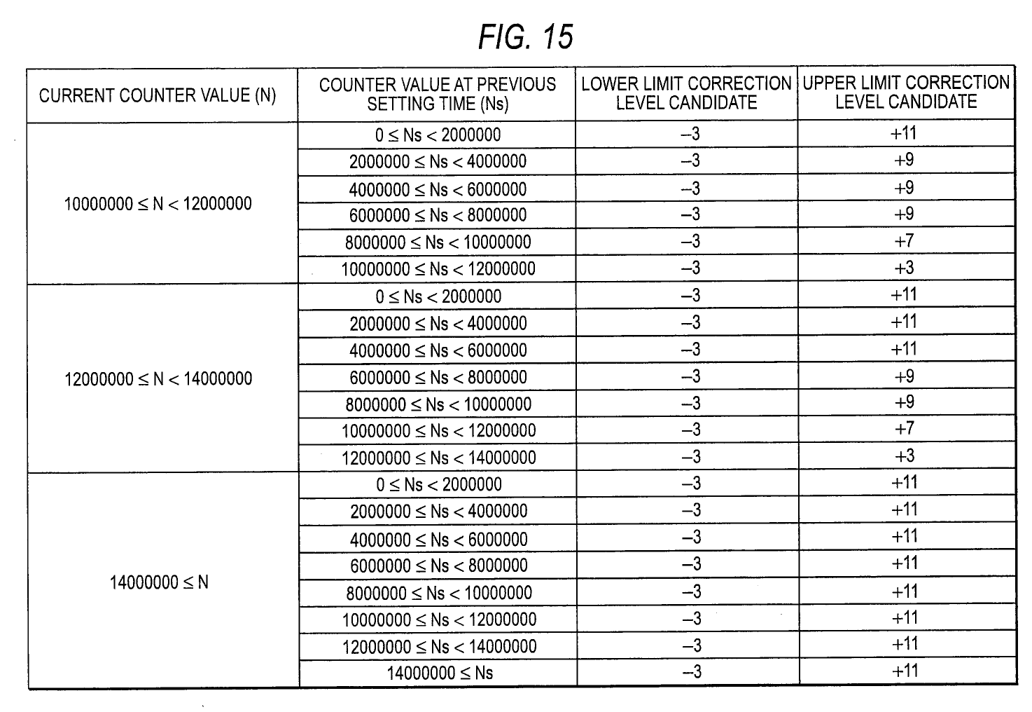

FIGS. 14 and 15 show an example of the correction level candidate data B. As shown in FIGS. 14 and 15, the correction level candidate data B includes a “current counter value” field, a “counter value at the previous setting time” field, a “lower limit correction level candidate” field, and an “upper limit correction level candidate” field. The correction level candidate B is a table in which a combination of the “current counter value” and the “counter value at the previous setting time” and a combination of the “lower limit correction level candidate” and the “upper limit correction level candidate” are corresponded to each other. Here, the “current counter value” field represents the range of the current counter value. The “counter value at the previous setting time” field represents the range of the counter value at the previous setting time. The “lower limit correction level candidate” field and the “upper limit correction level candidate” field are the same as those of the correction level candidate data A.

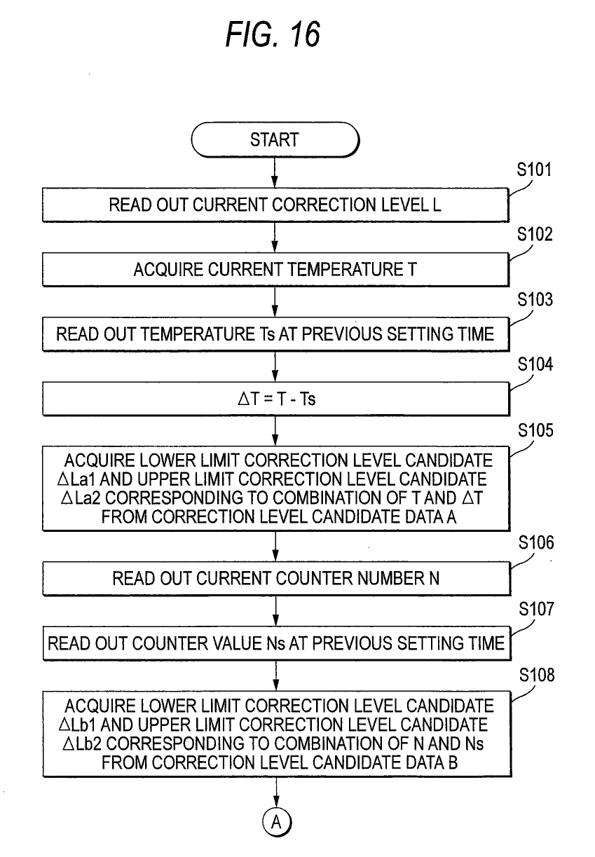

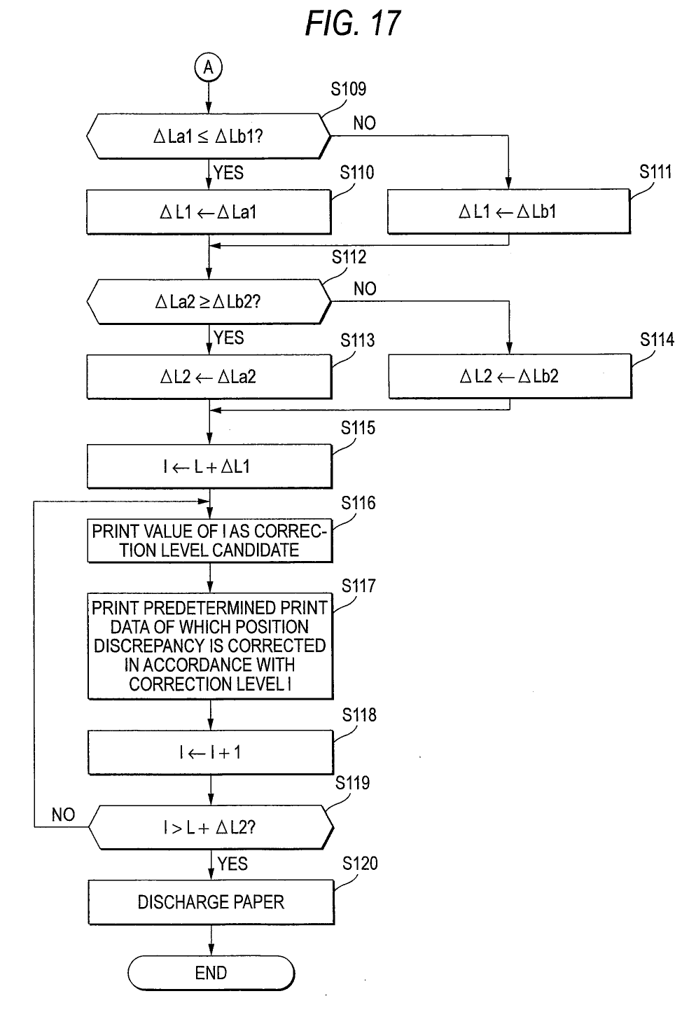

Next, a process performed by the printing apparatus 10 will be described. FIGS. 16 and 17 is a flowchart showing a process (hereinafter, referred to as a checking paper output process) for output of the misalignment correction checking paper 20. This process is performed when the checking paper output directing operation is performed. In addition, this process is performed by a program executed by the control unit 11.

As shown in FIG. 16, the printing apparatus 10 reads out the current correction level L from correction level data (S101). In addition, the printing apparatus 10 acquires a temperature detected at that moment by the temperature sensor 18 as the current temperature T (S102). Then, the printing apparatus 10 reads out the temperature Ts at the previous setting time from the state data at the previous setting time (S103). In addition, the printing apparatus 10 calculates the temperature difference ΔT by subtracting the temperature Ts at the previous setting time from the current temperature T (S104). Thereafter, the printing apparatus 10 acquires a lower limit correction level candidate ΔLa1 and an upper limit correction level candidate ΔLa2 corresponding to a combination of the current temperature T and the temperature difference ΔT from the correction level candidate data A (S105).

Then, the printing apparatus 10 acquires the current counter value N from the maintenance counter data (S106). In addition, the printing apparatus 10 reads out the counter value Ns at the previous setting time from the state data at the previous setting data (S107). Then, the printing apparatus 10 acquires a lower limit correction level candidate ΔLb1 and an upper limit correction level candidate ΔLb2 corresponding to a combination of the current counter value N and the counter value Ns at the previous setting time from the correction level candidate data B (S108).

Thereafter, the printing apparatus 10 compares the lower limit correction level candidate ΔLa1 and the lower limit correction level candidate ΔLb1 with each other (S109). When the lower limit correction level candidate ΔLa1 is equal to or smaller than the lower limit correction level candidate ΔLb1, the printing apparatus 10 sets ΔLa1 to a variable ΔL1 (S110). On the other hand, when the lower limit correction level candidate ΔLa1 is larger than the lower limit correction level candidate ΔLb1, the printing apparatus 10 sets ΔLb1 to the variable ΔL1 (S111).

Thereafter, the printing apparatus 10 compares the upper limit correction level candidate ΔLa2 and the upper limit correction level candidate ΔLb2 with each other (S112). When the upper limit correction level candidate ΔLa2 is equal to or larger than the upper limit correction level candidate ΔLb2, the printing apparatus 10 sets ΔLa2 to a variable ΔL2 (S113). On the other hand, when the upper limit correction level candidate ΔLa2 is smaller than the upper limit correction level candidate ΔLb2, the printing apparatus 10 sets ΔLb2 to the variable ΔL2 (S114).

Thereafter, the printing apparatus 10 initializes a variable l to be L+ΔL1 (S115). Then, the printing apparatus 10 prints a value of the variable l as a correction level candidate (S116). By performing this process, the correction level candidate 21 is printed on the misalignment correction checking paper 20. In addition, the printing apparatus 10 prints predetermined print data while performing misalignment correction in accordance with the correction level l (S117). In other words, the printing apparatus 10 reciprocates the print head once. In addition, the printing apparatus 10 prints a character string including a predetermined number of letters “H” in the forward and return paths while correcting the printing timings in accordance with a value (correction level) of the variable I. By performing this process, a printing example 22 is printed on the misalignment correction checking paper 20.

Thereafter, the printing apparatus 10 adds one to the value of the variable l (S118). Then, the printing apparatus 10 determines whether the value of the variable l is larger than L+ΔL2 (S119). When the value of l is equal to or smaller than L+ΔL2, the printing apparatus 10 performs the process of S116 to S119 again. On the other hand, when the value of l is larger than L+ΔL2, the printing apparatus 10 discharges the paper (S120) and ends this process.

When the checking paper output directing operation is performed, as described above, the misalignment correction checking paper 20, for example, as shown FIGS. 4 to 11, is output.

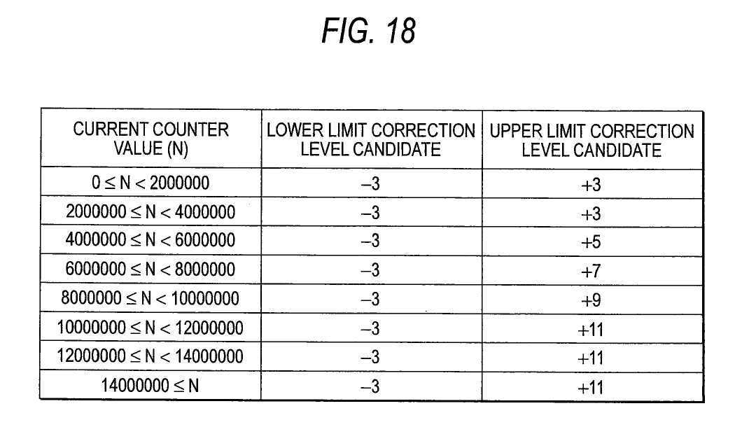

In the memory unit 12, for example, correction level candidate data B as shown in FIG. 18, replacing the correction level candidate data B shown in FIGS. 14 and 15, may be stored. In other words, the correction level candidate data B may be a table in which the current counter number and a combination of the lower limit correction level candidate and the upper limit correction level candidate are corresponded to each other. In such a case, the process of S107 is omitted in the checking paper output process (FIGS. 16 and 17). In addition, in the process of S108, the lower limit correction level candidate ΔLb1 and the upper limit correction level candidate ΔLb2 corresponding to the current counter value N are acquired from the correction level candidate data B.

Furthermore, the correction level candidates 21 presented on the misalignment correction checking paper 20 may be determined based on one of the temperatures detected by the temperature sensor 18 or the print line counter value.

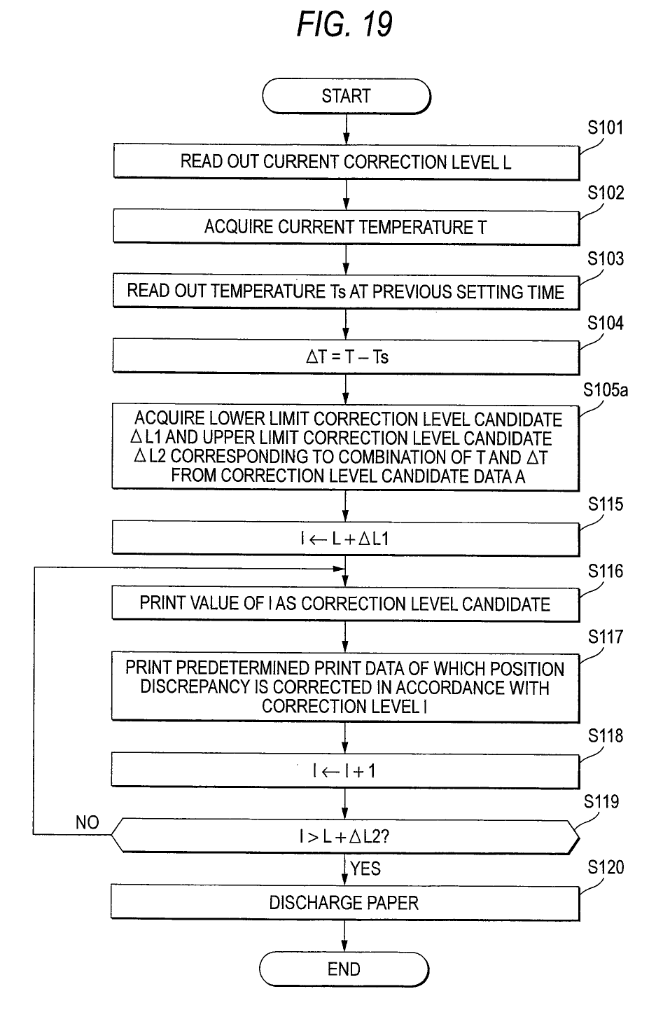

First, a case where the correction level candidates 21 presented on the misalignment correction checking paper 20 are determined based on only the temperature detected by the temperature sensor 18 will be described. FIG. 19 is a flowchart showing a checking paper output process in such a case. In FIG. 19, to the same processes as those shown in FIGS. 16 and 17, the same reference signs are attached.

As shown in FIG. 19, in the case, the printing apparatus 10 reads out the current correction level L from correction level data (S101). In addition, the printing apparatus 10 acquires a temperature detected at that moment by the temperature sensor 18 as the current temperature T (S102). Then, the printing apparatus 10 reads out the temperature Ts at the previous setting time from the state data at the previous setting time (S103). In addition, the printing apparatus 10 calculates the temperature difference ΔT by subtracting the temperature Ts at the previous setting time from the current temperature T (S104). Thereafter, the printing apparatus 10 acquires a lower limit correction level candidate ΔL1 and an upper limit correction level candidate ΔL2 corresponding to a combination of the current temperature T and the temperature difference ΔT from the correction level candidate data A (S105a).

Thereafter, the printing apparatus 10 initializes a variable l to be L+ΔL1 (S115). Then, the printing apparatus 10 prints a value of the variable l as a correction level candidate (S116). In addition, the printing apparatus 10 prints predetermined print data while performing misalignment correction in accordance with the correction level l (S117). Thereafter, the printing apparatus 10 adds one to the value of the variable l (S118). Then, the printing apparatus 10 determines whether the value of the variable l is larger than L+ΔL2 (S119). When the value of l is equal to or smaller than L+ΔL2, the printing apparatus 10 performs the process of S116 to S119 again. On the other hand, when the value of l is larger than L+ΔL2, the printing apparatus 10 discharges the paper (S120) and ends this process.

By performing the above-described process, the user can visually acquire a value of a correction level (a correction level at which the misalignment is the minimum) optimal to the printing apparatus 10 at once while reducing the printing examples 22 output on the misalignment correction checking paper 20. In addition, it is possible to ensure that the correction level optimal to the printing apparatus 10 is presented on the misalignment correction checking paper 20 as the correction level candidate 21 even when the temperature changes relatively much from that at the previous correction level setting time.

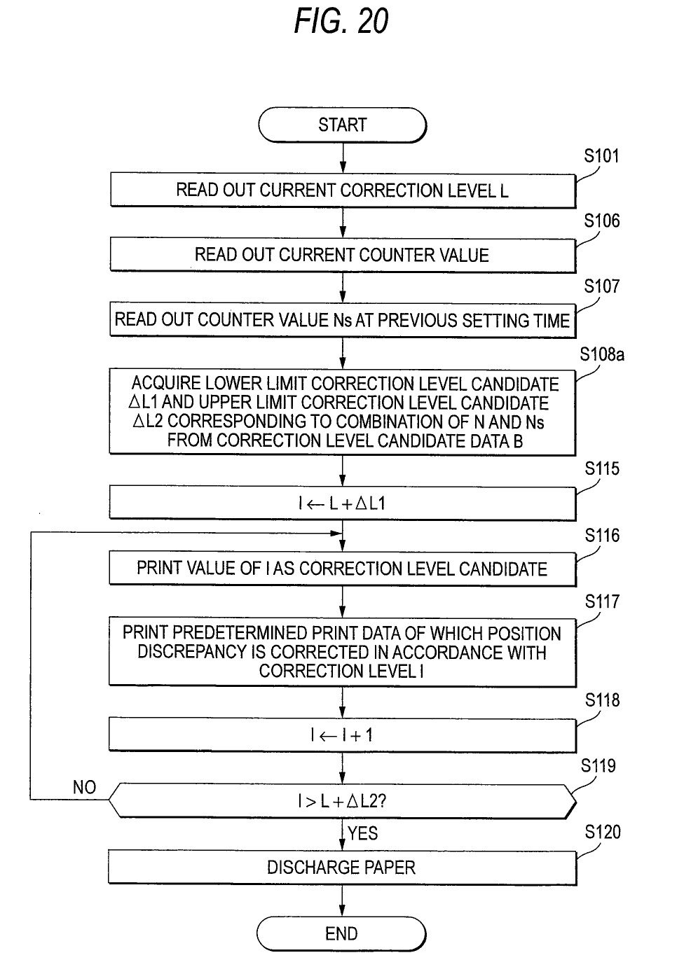

Next, a case where the correction level candidates 21 presented on the misalignment correction checking paper 20 are determined based on only the print line counter value will be described. FIG. 20 is a flowchart showing a checking paper output process in such a case. In FIG. 20, to the same processes as those shown in FIGS. 16 and 17, the same reference signs are attached.

As shown in FIG. 20, in the case, the printing apparatus 10 reads out the current correction level L from correction level data (S101). Then, the printing apparatus 10 acquires the current counter value N from the maintenance counter data (S106). In addition, the printing apparatus 10 reads out the counter value Ns at the previous setting time from the state data at the previous setting data (S107). Then, the printing apparatus 10 acquires a lower limit correction level candidate ΔL1 and an upper limit correction level candidate ΔL2 corresponding to a combination of the current counter value N and the counter value Ns at the previous setting time from the correction level candidate data B (S108a).

Thereafter, the printing apparatus 10 initializes a variable l to be L+ΔL1 (S115). Then, the printing apparatus 10 prints a value of the variable l as a correction level candidate (S116). In addition, the printing apparatus 10 prints predetermined print data while performing misalignment correction in accordance with the correction level l (S117). Thereafter, the printing apparatus 10 adds one to the value of the variable l (S118). Then, the printing apparatus 10 determines whether the value of the variable l is larger than L+ΔL2 (S119). When the value of l is equal to or smaller than L+ΔL2, the printing apparatus 10 performs the process of S116 to S119 again. On the other hand, when the value of l is larger than L+ΔL2, the printing apparatus 10 discharges the paper (S120) and ends this process.

By performing the above-described process, the user can visually acquire a value of a correction level (a correction level at which the misalignment is the minimum) optimal to the printing apparatus 10 at once while reducing the printing examples 22 output on the misalignment correction checking paper 20. In addition, it is possible to ensure that the correction level optimal to the printing apparatus 10 is presented on the misalignment correction checking paper 20 as the correction level candidate 21 even when the print line number counter value changes relatively much from that at the previous correction level setting time.

Also in this case, in the memory unit 12, correction level candidate data B as shown in FIG. 18, replacing the correction level candidate data B shown in FIGS. 14 and 15, may be stored.

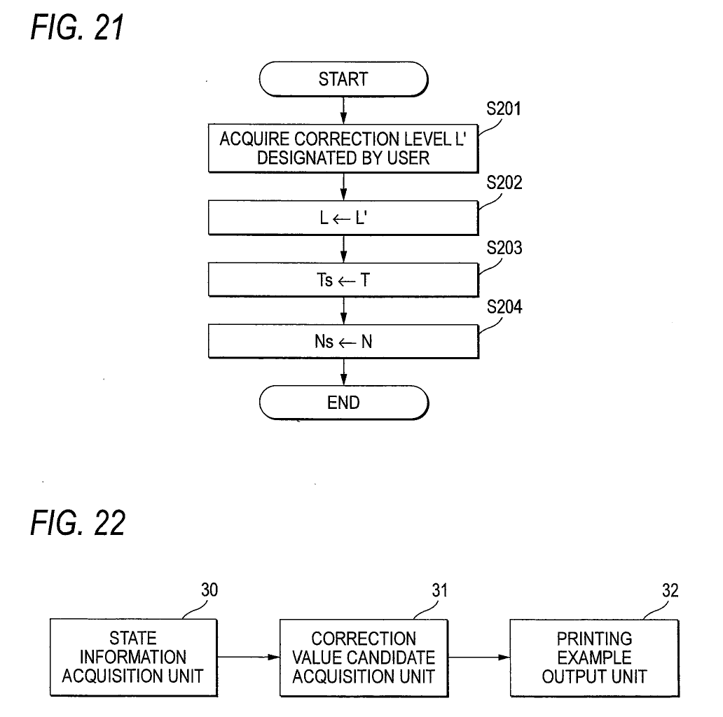

Next, a process (hereinafter, referred to as a correction level setting process) performed by the printing apparatus 10 at a time when the correction level designation operation is performed will be described. FIG. 21 is a flowchart showing the correction level setting process. This process is performed by a program executed by the control unit 11.

As shown in FIG. 21, when the correction level designating operation is performed, the printing apparatus 10 acquires a correction level L′ designed by the user (S201). Then, the printing apparatus 10 updates the current correction level L maintained in the correction level data to L′ (S202).

In addition, the printing apparatus 10 updates the temperature Ts at the previous setting time which is maintained in the state data at the previous setting time to the current temperature T (S203). In this step, the printing apparatus 10 acquires the current temperature T at this moment from the temperature sensor 18 and updates the temperature Ts at the previous setting time that is maintained in the state data at the previous setting time to the current temperature T. Alternatively, it may be configured that the printing apparatus 10 stores the current temperature T (the current temperature T acquired in S102) acquired at a time when the misalignment correction checking paper is output in the memory unit 12 and, in this step, the printing apparatus 10 updates the temperature Ts at the previous setting time maintained in the state data at the previous setting time to the current temperature T at a time when the misalignment correction checking paper is output.

In addition, the printing apparatus 10 updates the counter value Ns at the previous setting time maintained in the state data at the previous setting time to the current counter value N (S204). In this step, the printing apparatus 10 acquires the current counter value N at this moment from the maintenance counter data and updates the counter value Ns at the previous setting time maintained in the state data at the previous setting time to the current counter value N. Alternatively, it may be configured that the printing apparatus 10 stores the current counter value N (the current counter value N read in S106) acquired at a time when the misalignment correction checking paper is output in the memory unit 12 and, in this step, the printing apparatus 10 updates the counter value Ns at the previous setting time maintained in the state data at the previous setting time to the current counter value N at a time when the misalignment correction checking paper is output.

When the correction level designating operation is performed, as described above, the correction level designated by the user is stored, and the temperature at the previous setting time and the counter value at the previous setting time are stored.

Next, functions implemented by the printing apparatus 10 will be described. FIG. 22 is a functional block diagram mainly showing functions according to an embodiment of the invention from among functions implemented by the printing apparatus 10. As shown in FIG. 22, the printing apparatus 10 includes a state information acquisition unit 30 (an acquiring unit), a correction value candidate acquisition unit 31, and a printing example output unit 32, as functional components. These functions are performed by a program executed by the control unit 11.

The state information acquisition unit 30 is implemented by mainly the control unit 11 and the memory unit 12. The state information acquisition unit 30 acquires a temperature inside the printing apparatus 10 or an ambient temperature thereof. For example, the state information acquisition unit 30 acquires a temperature detected by the temperature sensor 18. Alternatively, the state information acquisition unit 30 may acquire a counter value that increases or decreases each time a predetermined operation is performed by the printing apparatus 10, in place of the temperature inside the printing apparatus 10 or the ambient temperature, or in addition to the temperatures. For example, the state information acquisition unit 30 reads out a value of the print line counter from the maintenance counter data shown in FIG. 2.

The correction value candidate acquisition unit 31 is implemented by mainly the control unit 11 and the memory unit 12. The correction value candidate acquisition unit 31 acquires correction level (correction value) candidates based on the temperature and/or the counter value acquired by the state information acquisition unit 30.

For example, the correction value candidate acquisition unit 31 (a correction value candidate information storing unit) stores the correction level candidate information in correspondence with a condition on the temperature inside the printing apparatus 10 or the ambient temperature. The correction level candidate information is information for acquisition of the correction level candidates. The correction value candidate acquisition unit 31, for example, stores the correction level candidate data A shown in FIG. 13. In this case, a temperature range represented by the “current temperature” of the correction level candidate data A or a temperature range represented by the “temperature difference” corresponds to the condition on the current temperature inside the printing apparatus 10 or the ambient temperature. In addition, the “upper limit correction level candidates” and “lower limit correction level candidates” of the correction level candidate data A correspond to the “correction level candidate information”. The correction value candidate acquisition unit 31 acquires the correction level candidates based on the correction level candidate information that is stored in correspondence with the condition satisfied by the temperature acquired by the state information acquisition unit 30.

In addition, for example, the correction value candidate acquisition unit 31 (a setting time temperature storing unit) stores a temperature at a time when the correction level is set by the user as a temperature at the setting time. The correction value candidate acquisition unit 31, for example, stores the state data at the previous setting time shown in FIG. 12. In this case, the “temperature at the previous setting time” of the state data at the previous setting time corresponds to the “temperature at the setting time”. In addition, the correction value candidate acquisition unit 31 (a correction value candidate information storing unit) stores the correction level candidate information in correspondence with a condition on the current temperature inside the printing apparatus 10 or the current ambient temperature and the temperature at the setting time. The correction value candidate acquisition unit 31, for example, stores the correction level candidate data A shown in FIG. 13. In this case, a temperature range represented by the “current temperature” of the correction level candidate data A or a temperature range represented by the “temperature difference” corresponds to the condition on the current temperature inside the printing apparatus 10 or the ambient temperature and the temperature at the setting time. The correction value candidate acquisition unit 31 acquires the correction level candidates based on the correction level candidate information that is stored in correspondence with a condition satisfied by the temperature acquired by the state information acquisition unit 30 and the temperature at the setting time stored in the correction value candidate acquisition unit 31.

In addition, the correction value candidate acquisition unit 31 (a correction value candidate information storing unit), for example, stores the correction level candidate information in correspondence with a condition on a counter value. The correction value candidate acquisition unit 31, for example, stores the correction level candidate data B shown in FIGS. 14 and 15 or the correction level candidate data B shown in FIG. 19. In this case, a range of the current counter value represented by the “current counter value” of the correction level candidate data B corresponds to the condition on the counter value. In addition the “upper limit correction level candidate” and “lower limit correction level candidate” of the correction level candidate data B correspond to the “correction level candidate information”. The correction value candidate acquisition unit 31 acquires the correction level candidates based on the correction level candidate information that is stored in correspondence with a condition satisfied by the counter value acquired by the state information acquisition unit 30.

In addition, the correction value candidate acquisition unit 31 (a setting time counter value storing unit), for example, stores a counter value at a time when the correction level is set by the user as the setting time counter value. The correction value candidate acquisition unit 31, for example, stores the state data at the previous setting time shown in FIG. 12. In this case, a “counter value at the previous setting time” of the state data at the previous setting time corresponds to the “setting time counter value”. In addition, the correction value candidate acquisition unit 31 (a correction value candidate information storing unit) stores the correction level candidate information in correspondence with a condition on the current counter value and the setting time counter value. The correction value candidate acquisition unit 31, for example, stores the correction level candidate data B shown in FIGS. 14 and 15. In this case, a range of the current counter value represented by the “current counter value” of the correction level candidate data B or a range of the counter value at the previous setting time represented by the “counter value at the previous setting time” corresponds to the “condition on the current counter value and the setting time counter value”. The correction value candidate acquisition unit 31 acquires the correction level candidates based on the correction level candidate information that is stored in correspondence with a condition satisfied by the current counter value acquired by the state information acquisition unit 30 and the setting time counter value stored in the correction value candidate acquisition unit 31.

The printing example output unit 32 is mainly implemented by the control unit 11. The printing example output unit 32 outputs printing examples corresponding to correction level candidates that are acquired by the correction value candidate acquisition unit 31. In other words, the printing example output unit 32 outputs printing examples that are corrected in correspondence with the correction level candidates for each correction level candidate acquired by the correction value candidate acquisition unit 31. The printing example output unit 32, for example, outputs the misalignment correction checking paper 20 shown in FIGS. 4 to 11. In this case, the printing examples 22 output on the misalignment correction checking paper 20 correspond to the “printing examples corresponding to the correction level candidates”.

As described above, according to the printing apparatus 10, it is possible to enable the user to visually acquire a value of a correction level (a correction level at which the misalignment is the minimum) optimal to the printing apparatus 10 at once while reducing the printing examples 22 output on the misalignment correction checking paper 20. In addition, according to the printing apparatus 10, it is possible to ensure that the correction level optimal to the printing apparatus 10 is presented on the misalignment correction checking paper 20 as the correction level candidate 21 even when the temperature or the print line number counter value changes relatively much from that at the previous correction level setting time.

The present invention is not limited to the above-described embodiments.

For example, in the checking paper output process shown in FIG. 17, the values of ΔL1 and ΔL2 may be determined by performing a predetermined calculation based on values of ΔLa1, ΔLb1, ΔLa2, and ΔLb2, instead of performing the process of S109 to S114. For example, the values of ΔL1 and ΔL2 may be determined by using the following equations (1) and (2).

ΔL1=ΔLa1+ΔLb1 (1)

ΔL2=ΔLa2+ΔLb2 (2)

In addition, for example, the correction level candidate data A may be configured to include a “temperature at the previous setting time” field representing a range of the temperature at the previous setting time in place of the “temperature difference” field. In such a case, the process of S104 can be omitted in the checking paper output process shown in FIG. 16 or 19. In addition, in the process of S105 or S105a, the lower limit correction level candidate and upper limit correction level candidate corresponding to a combination of the current temperature T and the temperature Ts at the previous setting time are acquired from the correction level candidate data A.

In addition, for example, the correction level candidate data B shown in FIGS. 14 and 15 may be configured to include a “counter increase value” field representing a range of an increase from the counter value at the previous setting time to the current counter value, in place of the “counter value at the previous setting time” field. In such a case, in the checking paper output process shown in FIG. 16 or FIG. 20, a counter increase value ΔN (=N−Ns) is calculated between the process of S107 and the process of S108 or S108a. In the process of S108 or S108a, the lower limit correction level candidate and upper level correction level candidate corresponding to a combination of the current counter value N the counter increase value ΔN are acquired from the correction level candidate data B.

In addition, for example, another maintenance counter may be used, in place of the print line number counter or together with print line number counter.

The present invention, for example, can be used for a serial printer apparatus such as a dot impact printer, an ink jet printer, or a thermal printer.

What is claimed is:

1. A printing apparatus comprising:
a printing unit that allows a print head to print on a recording medium in a forward path and a return path by reciprocating the print head with respect to the recording medium;
a correcting unit that performs correction for a misalignment between printing in the forward path and printing in the return path based on a correction value set by a user;
an acquisition unit that acquires a temperature inside the printing apparatus or an ambient temperature thereof and/or a counter value which increases or decreases each time a predetermined operation is performed by the printing apparatus;
a correction value candidate acquisition unit that acquires correction value candidates based on the temperature and/or the counter value acquired by the acquisition unit; and
a printing example output unit that outputs printing examples of which position discrepancies are corrected in accordance with correction value candidates for each correction value candidate acquired by the correction value candidate acquisition unit.

2. The printing apparatus according to claim 1,
wherein the correction value candidate acquisition unit includes a correction value candidate information storing unit that stores correction value candidate information used for acquisition of the correction value candidates in correspondence with a condition on the temperature, and acquires the correction value candidates based on the correction value candidate information that is stored in the correction value candidate information storing unit in correspondence with the condition satisfied by the temperature acquired by the acquisition unit.

3. The printing apparatus according to claim 2,
wherein the correction value candidate acquisition unit includes a setting time temperature storing unit that stores the temperature inside the printing apparatus or the ambient temperature at a time when the correction value is set by the user as a setting time temperature,
wherein the correction value candidate information storing unit stores the correction value candidate information in correspondence with a condition on the temperature and the setting time temperature, and
wherein the correction value candidate acquisition unit acquires the correction value candidates based on the correction value candidate information that is stored in the correction value candidate information storing unit in correspondence with the condition satisfied by the temperature acquired by the acquisition unit and the setting time temperature stored in the setting time temperature storing unit.

4. The printing apparatus according to claim 1,
wherein the correction value candidate acquisition unit includes a correction value candidate information storing unit that stores correction value candidate information used for acquisition of the correction value candidates in correspondence with a condition on the counter value, and acquires the correction value candidates based on the correction value candidate information that is stored in the correction value candidate information storing unit in correspondence with the condition satisfied by the counter value acquired by the acquisition unit.

5. The printing apparatus according to claim 4,
wherein the correction value candidate acquisition unit includes a setting time counter value storing unit that stores the counter value at a time when the correction value is set by the user as a setting time counter value,
wherein the correction value candidate information storing unit stores the correction value candidate information in correspondence with a condition on the counter value and the setting time counter value, and
wherein the correction value candidate acquisition unit acquires the correction value candidates based on the correction value candidate information that is stored in the correction value candidate information storing unit in correspondence with the condition satisfied by the counter value acquired by the acquisition unit and the setting time counter value stored in the setting time counter value storing unit.

6. A control method for a printing apparatus including a printing unit that allows a print head to print on a recording medium in a forward path and a return path by reciprocating the print head with respect to the recording medium and a correcting unit that performs correction for a misalignment between printing in the forward path and printing in the return path based on a correction value set by a user, the control method comprising:
acquiring a temperature inside the printing apparatus or an ambient temperature thereof and/or a counter value which increases or decreases each time a predetermined operation is performed by the printing apparatus;
acquiring correction value candidates based on the temperature and/or the counter value which are acquired by the acquiring of a temperature and/or a counter; and
outputting printing examples of which position discrepancies are corrected in accordance with correction value candidates for each correction value candidate acquired by the acquiring of correction value candidates.
